(19) United States
(12) Patent Application Publication
(10) Pub. No.: US 2020/0411012 A1
(43) Pub. Date: Dec. 31, 2020

(54) SPEECH RECOGNITION DEVICE, SPEECH RECOGNITION SYSTEM, AND SPEECH RECOGNITION METHOD

(71) Applicant: Mitsubishi Electric Corporation, Tokyo (JP)

(72) Inventors: Naoya BABA, Tokyo (JP); Takumi TAKEI, Tokyo (JP)

(73) Assignee: Mitsubishi Electric Corporation, Tokyo (JP)

(21) Appl. No.: 16/767,319

(22) PCT Filed: Dec. 25, 2017
(86) PCT No.: PCT/JP2017/046469

§ 371 Date: May 27, 2020

(51) Int. Cl. G10L 17/22; G06K 9/00; B60N 2/00; B60K 35/00; B60R 16/023; B60R 11/04

(52) U.S. Cl. CPC G10L 17/22; G06K 9/00838; B60N 2/002; B60K 35/00; B60R 16/0231; B60R 2011/0003; G06K 9/00228; B60K 2370/148; B60K 2370/1575; B60K 2370/152; B60R 11/04

(57) ABSTRACT

A speech recognition device includes: a speech recognition unit for executing speech recognition on a spoken sound that is made for an operational input by a speaking person among multiple on-board persons seated on speech recognition target seats in a vehicle; a speaking person identification unit for executing at least one of personal identification processing of identifying the speaking person, and seat identification processing of identifying the seat on which the speaking person is seated; and a response mode setting unit for executing response mode setting processing of setting a mode for a response to the speaking person, according to a result identified by the speaking person identification unit; the response mode setting processing is processing in which the mode for the response is set as a mode that allows each of the multiple on-board persons to determine whether to be subjected to the response.

### TECHNICAL FIELD

The present invention relates to a speech recognition device, a speech recognition system and a speech recognition method.

### BACKGROUND ART

Speech recognition devices for providing operational inputs to information apparatuses in vehicles, have heretofore been developed. Hereinafter, a seat that is subject to speech recognition in the vehicle is referred to as a “speech recognition target seat”. Further, among the on-board persons seated on the speech recognition target seats, a person who has made a speech for providing the operational input is referred to as a “speaking person”. Further, the speech that is made for providing the operational input by the speaking person, is referred to as a “spoken sound”.

In Patent Literature 1, there is disclosed a technique for identifying, out of a driver's seat and a front passenger's seat that are speech recognition target seats, a seat on which a speaking person is seated. With this technique, an adequate operational input is achieved in the case where multiple on-board persons are seated on the speech recognition target seats.

### CITATION LIST

### Patent Literature

Patent Literature 1: Japanese Patent Application Laid-open No. H11-65587

### SUMMARY OF INVENTION

### Technical Problem

Recently, a speech recognition device that is associated with a UI (User Interface) of a so-called “interactive type” has been developed. Namely, such a UI has been developed that, in addition to receiving the operational input by executing speech recognition on a spoken sound, causes a speaker to output a speech for use as a response to the spoken sound (hereinafter, referred to as a “response speech”), and/or causes a display to display an image for use as a response to the spoken sound (hereinafter, referred to as a “response image”). Hereinafter, the response speech, the response image and the like according to the interactive-type UI may be collectively referred to simply as a “response”.

According to the speech recognition device associated with the interactive-type UI, in the case where multiple on-board persons are seated on the speech recognition target seats, a response is outputted to the speaking person in the multiple on-board persons. On this occasion, there is a problem that, for each of the multiple on-board persons, it is difficult to recognize whether or not the response is given to the on-board person himself/herself. In particular, there is a problem that such recognition becomes more difficult when responses to multiple speaking persons are outputted at almost the same time.

This invention has been made to solve the problems as described above, and an object thereof is to inform each of the multiple on-board persons seated on the speech recognition target seats, of whether or not a response according to the interactive-type UI is given to the on-board person himself/herself.

### Solution to Problem

A speech recognition device of the invention is characterized by comprising: a speech recognition unit for executing speech recognition on a spoken sound that is made for an operational input by a speaking person among multiple on-board persons seated on speech recognition target seats in a vehicle, a speaking person identification unit for executing at least one of personal identification processing of individually identifying the speaking person; and seat identification processing of identifying the seat on which the speaking person is seated, and a response mode setting unit for executing response mode setting processing of setting a mode for a response to the speaking person, in accordance with a result identified by the speaking person identification unit, and the response mode setting processing is processing in which the mode for the response is set as a mode that allows each of the multiple on-board persons to recognize whether the response is given to itself.

### Advantageous Effects of Invention

According to the invention, because of the configuration as described above, it is possible to inform each of the multiple on-board persons seated on the speech recognition target seats, of whether or not a response according to the interactive-type UI is given to the on-board person himself/herself.

### BRIEF DESCRIPTION OF DRAWINGS

FIG. 1 is a block diagram showing a state in which a speech recognition device according to Embodiment 1 of the invention is provided in an information apparatus in a vehicle.

FIG. 2 is an illustration diagram showing a state in which a response image is displayed on a display device.

FIG. 3 is an illustration diagram showing a state in which another response image is displayed on the display device.

FIG. 4A is a block diagram showing a hardware configuration of an information apparatus in which the speech recognition device according to Embodiment 1 of the invention is provided. FIG. 4B is a block diagram showing another hardware configuration of an information apparatus in which the speech recognition device according to Embodiment 1 of the invention is provided.

FIG. 5 is a flowchart showing operations of an information apparatus in which the speech recognition device according to Embodiment 1 of the invention is provided.

FIG. 6 is a flowchart showing detailed operations of a speech recognition unit in the speech recognition device according to Embodiment 1 of the invention.

FIG. 7 is a block diagram showing a main part of a speech recognition system according to Embodiment 1 of the invention.

FIG. 8 is a block diagram showing a state in which a speech recognition device according to Embodiment 2 of the invention is provided in an information apparatus in a vehicle.

FIG. 9 is a flowchart showing an operation of an on-board person identification unit in the speech recognition device according to Embodiment 2 of the invention.

FIG. 10 is a flowchart showing detailed operations of the on-board person identification unit in the speech recognition device according to Embodiment 2 of the invention.

FIG. 11 is a flowchart showing operations of parts other than the on-board person identification unit, in the information apparatus in which the speech recognition device according to Embodiment 2 of the invention is provided.

FIG. 12 is a flowchart showing detailed operations of a speech recognition unit in the speech recognition device according to Embodiment 2 of the invention.

FIG. 13 is a block diagram showing a state in which another speech recognition device according to Embodiment 2 of the invention is provided in an information apparatus in a vehicle.

FIG. 14 is a block diagram showing a state in which another speech recognition device according to Embodiment 2 of the invention is provided in an information apparatus in a vehicle.

FIG. 15 is a block diagram showing a main part of a speech recognition system according to Embodiment 2 of the invention.

### DESCRIPTION OF EMBODIMENTS

Hereinafter, for illustrating the invention in more detail, embodiments for carrying out the invention will be described with reference to the accompanying drawings.

### Embodiment 1

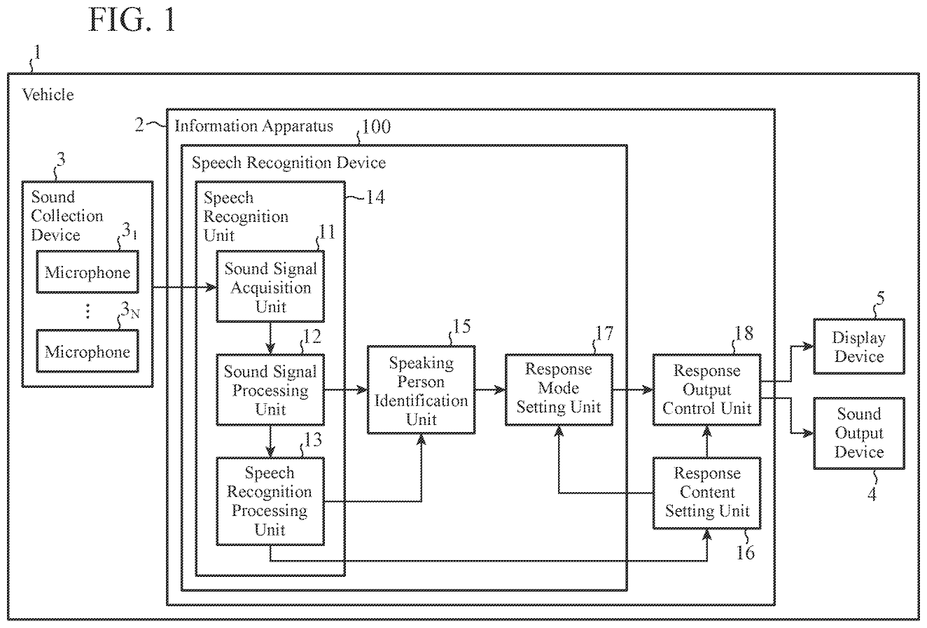

FIG. 1 is a block diagram showing a state in which a speech recognition device according to Embodiment 1 is provided in an information apparatus in a vehicle. With reference to FIG. 1, description will be made about a speech recognition device 100 of Embodiment 1, focusing on a case where it is provided in an information apparatus 2 in a vehicle 1.

In the figure, reference numeral 3 denotes a sound collection device. The sound collection device 3 is configured with, for example, N number of microphones 3₁ to 3_{N} (N denotes an integer of 2 or more) that are provided in a vehicle-interior front section of the vehicle 1. More specifically, for example, the microphones 3₁ to 3_{N} are each configured as a non-directional microphone, and the microphones 3₁ to 3_{N} arranged at constant intervals constitute an array microphone. The sound collection device 3 serves to output signals (hereinafter, each referred to as a “sound signal”) S₁ to S_{N} that are corresponding to the respective sounds collected by the microphones 3₁ to 3_{N}. Namely, the sound signals S₁ to S_{N} correspond one-to-one to the microphones 3₁ to 3_{N}.

A sound signal acquisition unit 11 serves to acquire the sound signals S₁ to S_{N} outputted by the sound collection device 3. The sound signal acquisition unit serves to execute analog-to-digital conversion (hereinafter, referred to as “A/D conversion”) on the sound signals S₁ to S_{N} by using, for example, PCM (Pulse Code Modulation). The sound signal acquisition unit 11 serves to output sound signals S₁′ to S_{N}′ after A/D conversion, to a sound signal processing unit 12.

The sound signal processing unit 12 serves to estimate an incoming direction of the spoken sound to the sound collection device 3 (hereinafter, referred to as a “speaking direction”). Specifically, for example, the sound collection device 3 is placed in the vehicle-interior front section of the vehicle 1 and at a center portion with respect to the horizontal direction of the vehicle 1. Hereinafter, an axis that passes the placement position of the sound collection device 3 and that is parallel to the longitudinal direction of the vehicle 1, is referred to as a “central axis”. The sound signal processing unit 12 estimates the speaking direction represented by a horizontal direction angle θ relative to the central axis that is referenced to the placement position of the sound collection device 3, on the basis of: values of differences in power between the sound signals S₁′ to S_{N}′; phase differences between the sound signals S₁′ to S_{N}′; or the like.

Further, the sound signal processing unit 12 serves to remove each component in the sound signals S₁′ to S_{N}′ that is corresponding to a sound inputted to the sound collection device 3 from a direction that is different to the thus-estimated speaking direction, and thus to remove components corresponding to sounds different to the spoken sound (hereinafter, each referred to as a “noise component”). The sound signal processing unit 12 serves to output sound signals S₁″ to S_{M}″ after removal of the noise components, to a speech recognition processing unit 13. Note that the symbol M denotes an integer of N or less, and is, for example, a number corresponding to the seat number of the speech recognition target seats.

The noise components include, for example, a component corresponding to a noise caused by the traveling of the vehicle 1, a component corresponding to a sound spoken by an on-board person other than the speaking person among the on-board persons of the vehicle 1 (that is, a component corresponding to a sound not for providing an operational input, caused by a conversation between on-board persons, or the like), and the like. In order to remove the noise components in the sound signal processing unit 12, any one of publicly known various methods, such as a beamforming method, a binary masking method, a spectrum subtraction method or the like, may be used. Accordingly, detailed description on how to remove the noise components in the sound signal processing unit 12 will be omitted.

The speech recognition processing unit 13 serves to detect a sound section corresponding to the spoken sound (hereinafter, referred to as a “speaking section”) in the sound signals S₁″ to S_{M}″. The speech recognition processing unit 13 serves to extract a feature amount for speech recognition processing (hereinafter, referred to as a “first feature amount”) from portions of the sound signals S₁″ to S_{M}″ in the speaking section. The speech recognition processing unit 13 serves to execute speech recognition processing by using the first feature amount.

For the speech recognition processing in the speech recognition processing unit 13, any one of publicly known various methods, such as an HMM (Hidden Markov Model) method or the like, may be used. Accordingly, detailed description on the speech recognition processing in the speech recognition processing unit 13 will be omitted.

Further, the speech recognition processing unit 13 serves to extract a feature amount (hereinafter, referred to as a “second feature amount”) for processing of individually identifying the speaking person (hereinafter, referred to as “personal identification processing”) from portions of the sound signals S₁″ to S_{M}″ in the speaking section.

By the sound signal acquisition unit 11, the sound signal processing unit 12 and the speech recognition processing unit 13, a speech recognition unit 14 is constituted. Namely, the speech recognition unit 14 serves to execute speech recognition on the spoken sound.

It is noted that, when there is only one speaking person, the speech recognition unit 14 executes speech recognition on the spoken sound made by the only one speaking person. On the other hand, when there are multiple speaking persons, the speech recognition unit 14 executes speech recognition on each of the spoken sounds made by the multiple speaking persons.

A speaking person identification unit 15 serves to execute the personal identification processing by using the second feature amount extracted by the speech recognition processing unit 13.

Specifically, in the speaking person identification unit 15, for example, a database is prestored in which feature amounts of multiple persons each corresponding to a second feature amount are included. By comparing the second feature amount extracted by the speech recognition processing unit 13 with each of the feature amounts of multiple persons, the speaking person identification unit 15 individually identifies the speaking person.

Instead, the speaking person identification unit 15 serves to execute processing of identifying, out of the speech recognition target seats, a seat on which the speaking person is seated (hereinafter, referred to as “seat identification processing”), on the basis of the speaking direction estimated by the sound signal processing unit 12.

Specifically, for example, angles Φ that are relative to the central axis referenced to the placement position of the sound collection device 3 and that indicate the positions of the respective speech recognition target seats (hereinafter, each referred to as an “actual angle”), have been measured beforehand, and the actual angles Φ of the respective speech recognition target seats are prestored in the speaking person identification unit 15. By comparing the angle θ indicated by the speaking direction estimated by the sound signal processing unit 12 with each of the actual angles Φ corresponding to the speech recognition target seats, the speaking person identification unit 15 identifies the seat on which the speaking person is seated.

For example, let's assume that the driver's seat and the front passenger's seat in the vehicle 1 are speech recognition target seats, and an actual angle Φ of +20° corresponding to the driver's seat and an actual angle Φ of −20° corresponding to the front passenger's seat are prestored in the speaking person identification unit 15. In this situation, when the angle θ indicated by the speaking direction estimated by the sound signal processing unit 12 is +18°, the speaking person identification unit 15 identifies that the seat on which the speaking person is seated is the driver's seat.

Instead, the speaking person identification unit 15 serves to execute both the personal identification processing and the seat identification processing.

It is noted that, when there is only one speaking person, the personal identification processing is processing of identifying the only one speaking person; and the seat identification processing is processing of identifying the seat on which the only one speaking person is seated. On the other hand, when there are multiple speaking persons, the personal identification processing is processing of identifying each of the multiple speaking persons; and the seat identification processing is processing of identifying each of the seats on which the multiple speaking persons are seated.

Further, when the speaking person identification unit 15 is that which executes only the personal identification processing, a connection line shown in FIG. 1 between the sound signal processing unit and the speaking person identification unit 15 is unnecessary. Further, when the speaking person identification unit 15 is that which executes only the seat identification processing, it is not required to extract the second feature point by the speech recognition processing unit 13, and a connection line shown in FIG. 1 between the speech recognition processing unit 13 and the speaking person identification unit 15 is unnecessary.

A response content setting unit 16 serves to execute processing of setting the content (hereinafter, referred to as “response content”) of the response to the spoken sound (hereinafter, referred to as “response content setting processing”). A response mode setting unit 17 serves to execute processing of setting a mode (hereinafter, referred to as a “response mode”) for the response to the spoken sound (hereinafter, referred to as “response mode setting processing”). A response output control unit 18 serves to execute output control of the response to the spoken sound (hereinafter, referred to as “response output control”) on the basis of the response content set by the response content setting unit 16 and the response mode set by the response mode setting unit 17.

Specifically, for example, the response mode setting unit 17 sets an output mode for the response speech. The response output control unit 18 generates, using so-called “speech synthesis”, the response speech based on the output mode set by the response mode setting unit 17. The response output control unit 18 executes control for causing a sound output device 4 to output the thus-generated response speech. The sound output device 4 is configured with, for example, multiple speakers.

For the speech synthesis in the response output control unit 18, any one of publicly known various methods may be used. Accordingly, detailed description on the speech synthesis in the response output control unit 18 will be omitted.

For further example, the response mode setting unit 17 sets a display mode for the response image. The response output control unit 18 generates the response image based on the display mode set by the response mode setting unit 17. The response output control unit 18 executes control for causing a display device 5 to display the thus-generated response image. The display device 5 is configured with a display, for example, a liquid crystal display, an organic EL (Electro Luminescence) display, or the like.

It is noted that, when there is only one speaking person, the response content setting processing is processing of setting the content of the response to the only one speaking person; the response mode setting processing is processing of setting the mode for the response to the only one speaking person; and the response output control is output control of the response to the only one speaking person. On the other hand, when there are multiple speaking persons, the response content setting processing is processing of setting the content of the respective responses to the multiple speaking persons; the response mode setting processing is processing of setting the modes for the respective responses to the multiple speaking persons; and the response output control is output control of the respective responses to the multiple speaking persons.

In the followings, description will be made about specific examples of the response content setting processing, the response mode setting processing and the response output control.

<Specific Example of Response Content Setting Processing>

The response content setting unit 16 acquires the result of the speech recognition processing by the speech recognition processing unit 13. The response content setting unit 16 selects from among prestored multiple response sentences, a response sentence that is matched with the result of the speech recognition processing. The selection at this time may be based on a prescribed rule related to correspondence relationships between the result of the speech recognition processing and the prestored multiple response sentences, or may be based on a statistical model according to the results of machine learning using a large number of interactive sentence examples.

In is noted that the response content setting unit 16 may be that which acquires weather information, schedule information or the like, from so-called “Cloud”, to thereby generate a response sentence containing such information.

<First Specific Example of Response Mode Setting Processing and Response Output Control>

The response mode setting unit 17 acquires the result of the personal identification processing by the speaking person identification unit 15. Further, the response mode setting unit 17 acquires the response sentence (hereinafter, referred to as an “output response sentence”) selected or generated by the response content setting unit 16. On the basis of the name or the like of the speaking person indicated by the result of the personal identification processing, the response mode setting unit 17 adds a nominal designation for that speaking person to the output response sentence. The response output control unit 18 generates a response speech or a response image corresponding to the output response sentence containing the nominal designation.

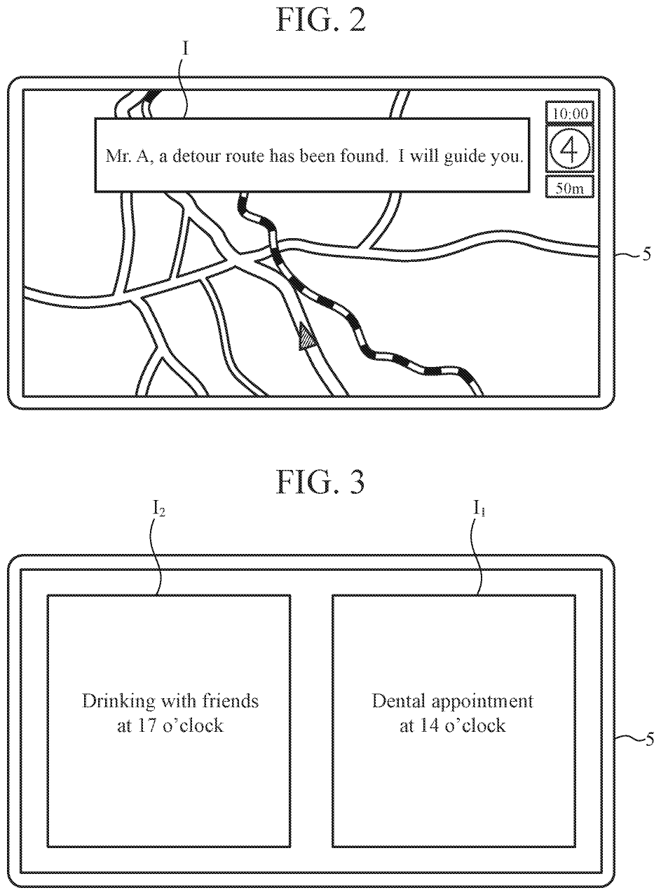

For example, let's assume that, in response to the spoken sound of “Search a detour route” made by the speaking person seated on the driver's seat, the result of the personal identification processing indicates a name “A” of that speaking person, and the response content setting unit 16 selects the output response sentence of “Searching a detour route has been made. I will guide you”. In this case, the response mode setting unit 17 adds the nominal designation to the head portion in the output response sentence selected by the response content setting unit 16, to thereby generates an output response sentence of “Dear A, searching a detour route has been made. I will guide you”. The response output control unit 18 generates a response speech or a response image corresponding to the output response sentence generated by the response mode setting unit 17. In FIG. 2, an example of a response image I according to this case is shown.

For further example, let's assume that, in response to the spoken sound of “Tell me my today's schedule” made by the speaking person seated on the driver's seat, the result of the personal identification processing indicates a name “A” of that speaking person, and the response content setting unit 16 generates using the schedule information, the output response sentence of “Today, you have a dental appointment at 14 o'clock”. In addition, let's assume that, in response to the spoken sound of “Tell me also my schedule” made by the speaking person seated on the front passenger's seat, the result of the personal identification processing indicates a name “B” of that speaking person, and the response content setting unit 16 generates using the schedule information, the output response sentence of “Today, you have a drinking party with friends at 17 o'clock”.

In this case, the response mode setting unit 17 adds the nominal designation to the head portion in each of the output response sentences generated by the response content setting unit 16, to thereby generates an output response sentence of “Dear A, today, you have a dental appointment at 14 o'clock” and an output response sentence of “Dear B, today, you have a drinking party with friends at 17 o'clock”. The response output control unit 18 generates respective response speeches or response images corresponding to these output response sentences.

Alternatively, the response mode setting unit acquires the result of the seat identification processing by the speaking person identification unit 15. Further, the response mode setting unit 17 acquires the output response sentence selected or generated by the response content setting unit 16. On the basis of the name or the like of the seat indicated by the result of the seat identification processing, the response mode setting unit 17 adds a nominal designation for the speaking person to the output response sentence. The response output control unit 18 generates a response speech or a response image corresponding to the output response sentence containing the nominal designation.

For example, let's assume that, in response to the spoken sound of “Tell me nearby parking lots” made by the speaking person seated on the driver's seat, the result of the seat identification processing indicates the “driver's seat”, and the response content setting unit 16 generates the output response sentence of “Three nearby parking lots are found”. In addition, let's assume that, in response to the spoken sound of “I want to listen to music” made by the speaking person seated on the front passenger's seat, the result of the seat identification processing indicates the “front passenger's seat”, and the response content setting unit 16 selects the output response sentence of “What genre of music would you like to looking for?”.

In this case, the response mode setting unit 17 adds a nominal designation to the head portion in each of the output response sentences generated or selected by the response content setting unit 16, to thereby generate an output response sentence of “Dear driver, three nearby parking lots are found” and an output response sentence of “Dear front-seat passenger, what genre of music would you like to looking for?”. The response output control unit 18 generates respective response speeches or response images corresponding to these output response sentences.

<Second Specific Example of Response Mode Setting Processing and Response Output Control>

The response mode setting unit 17 acquires the result of the personal identification processing by the speaking person identification unit 15. With respect to the speech synthesis in the response output control unit 18, the narrator of the response speech is selectable from multiple narrators. The response mode setting unit 17 resets a given narrator of the response speech to a different narrator according to the speaking person indicated by the result of the personal identification processing.

Alternatively, the response mode setting unit acquires the result of the seat identification processing by the speaking person identification unit 15. With respect to the speech synthesis in the response output control unit 18, the narrator of the response speech is selectable from multiple narrators. The response mode setting unit 17 resets a given narrator of the response speech to a different narrator according to the seat indicated by the result of the seat identification processing.

<Third Specific Example of Response Mode Setting Processing and Response Output Control>

The response mode setting unit 17 acquires the result of the seat identification processing by the speaking person identification unit 15. The response mode setting unit 17 sets, out of the multiple speakers included in the sound output device 4, a speaker as the speaker to be used for outputting the response speech according to the position of the seat indicated by the result of the seat identification processing. The response output control unit 18 controls so that the response speech is outputted from the speaker set by the response mode setting unit 17.

For example, let's assume that the sound output device 4 is configured with a pair of right and left front speakers, and the result of the seat identification processing indicates the “driver's seat”. In this case, the response mode setting unit 17 sets, out of the front speakers, the speaker on the driver's seat-side as the speaker to be used for outputting the response speech. The response output control unit 18 controls so that the response speech is outputted from the speaker on the driver's seat-side out of the front speakers.

Likewise, let's assume that the sound output device 4 is configured with a pair of right and left front speakers, and the result of the seat identification processing indicates the “front passenger's seat”. In this case, the response mode setting unit 17 sets, out of the front speakers, the speaker on the front passenger's seat-side as the speaker to be used for outputting the response speech. The response output control unit 18 controls so that the response speech is outputted from the speaker on the front passenger's seat-side out of the front speakers.

<Fourth Specific Example of Response Mode Setting Processing and Response Output Control>

The response mode setting unit 17 acquires the result of the seat identification processing by the speaking person identification unit 15. The response output control unit 18 has a function of controlling a sound field in the interior of the vehicle 1 at the time the response speech is outputted. The response mode setting unit 17 sets the sound field at the time the response speech is outputted according to the position of the seat indicated by the result of the seat identification processing. The response output control unit 18 causes the sound output device 4 to output the response speech so that the sound field set by the response mode setting unit 17 is established in the interior of the vehicle 1.

For example, let's assume that the result of the seat identification processing indicates the “driver's seat”. In this case, the response mode setting unit 17 sets the sound field so that the sound volume of the response speech at the driver's seat is larger than the sound volume of the response speech at any other seat. The response output control unit 18 causes the sound output device 4 to output the response speech so that such a sound field is established in the interior of the vehicle 1.

Likewise, let's assume that the result of the seat identification processing indicates the “front passenger's seat”. In this case, the response mode setting unit 17 sets the sound field so that the sound volume of the response speech at the front passenger's seat is larger than the sound volume of the response speech at any other seat. The response output control unit 18 causes the sound output device 4 to output the response speech so that such a sound field is established in the interior of the vehicle 1.

<Fifth Specific Example of Response Mode Setting Processing and Response Output Control>

The response mode setting unit 17 acquires the result of the seat identification processing by the speaking person identification unit 15. The response mode setting unit 17 sets a region where the response image is to be displayed in the display area of the display device 5 according to the position of the seat indicated by the result of the seat identification processing. The response output control unit 18 causes the response image to be displayed in the region set by the response mode setting unit 17.

For example, let's assume that, in response to the spoken sound of “Tell me my today's schedule” made by the speaking person seated on the driver's seat, the response content setting unit 16 generates using the schedule information, the output response sentence of “Today, you have a dental appointment at 14 o'clock”. In addition, let's assume that, in response to the spoken sound of “Tell me also my schedule” made by the speaking person seated on the front passenger's seat, the response content setting unit 16 generates, using the schedule information, the output response sentence of “Today, you have a drinking party with friends at 17 o'clock”.

In this case, the response mode setting unit 17 sets the response image corresponding to the output response sentence for the speaking person seated on the driver's seat, to be displayed in the half nearer to the driver's seat, of the display area of the display device 5. In addition, the response mode setting unit 17 sets the response image corresponding to the output response sentence for the speaking person seated on the front passenger's seat, to be displayed in the half nearer to the front passenger's seat, of the display area of the display device 5. In FIG. 3, an example of response images I₁, I₂ according to this case is shown.

The response mode setting unit 17 executes the response mode setting processing according to at least one of the first specific example to the fifth specific example. This makes it possible for each of the multiple on-board persons seated on the speech recognition target seats, to easily recognize whether or not the response is given to that person himself/herself. In particular, when the responses to multiple speaking persons are outputted at almost the same time, this makes it possible for each of the multiple speaking persons to easily recognize whether or not these responses are each given to that person himself/herself.

It is noted that, when the response mode setting unit 17 is that which executes the response mode setting processing according to the first specific example, the output response sentence containing the nominal designation is outputted from the response mode setting unit 17 to the response output control unit 18. On the other hand, when the response mode setting unit 17 is that which does not execute the response mode setting processing according to the first specific example, the output response sentence selected or generated by the response content setting unit 16 is outputted from the response content setting unit 16 to the response output control unit 18. Further, in each of the second to fifth specific examples, the output response sentence is not used in the response mode setting processing.

Thus, when the response mode setting unit 17 is that which executes the response mode setting processing according to the first specific example, a connection line shown in FIG. 1 between the response content setting unit 16 and the response output control unit 18 is unnecessary. On the other hand, when the response mode setting unit 17 is that which does not execute the response mode setting processing according to the first specific example (namely, when the response mode setting unit 17 executes only one of response mode setting processing according to at least one of the second to fifth specific examples), a connection line shown in FIG. 1 between the response content setting unit 16 and the response mode setting unit 17 is unnecessary.

By the speech recognition unit 14, the speaking person identification unit 15 and the response mode setting unit 17, the main part of the speech recognition device 100 is constituted. By the speech recognition device 100, the response content setting unit 16 and the response output control unit 18, the main part of the information apparatus 2 is constituted.

The information apparatus 2 is configured with an in-vehicle information device, for example, a car navigation device, a car audio device, a display audio device or the like, installed in the vehicle 1. Alternatively, the information apparatus 2 is configured with a portable information terminal, for example, a smartphone, a tablet PC (personal computer), a PND (Portable Navigation Device) or the like, brought into the vehicle 1.

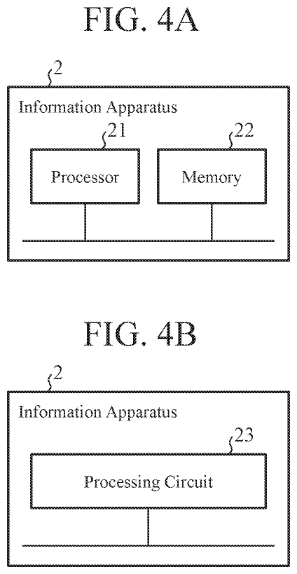

Next, with reference to FIG. 4, description will be made about hardware configurations of the main part of the information apparatus 2.

As shown in FIG. 4A, the information apparatus 2 is configured with a computer, and has a processor 21 and a memory 22. In the memory 22, respective programs for causing the computer to function as the speech recognition unit 14, the speaking person identification unit 15, the response content setting unit 16, the response mode setting unit 17 and the response output control unit 18, are stored. The processor 21 reads out and executes the programs stored in the memory 22, to thereby implement the functions of the speech recognition unit 14, the speaking person identification unit 15, the response content setting unit 16, the response mode setting unit 17 and the response output control unit 18.

The processor 21 uses, for example, a CPU (Central Processing Unit), a GPU (Graphics Processing Unit), a microprocessor, a microcontroller, a DSP (Digital Signal Processor) or the like. The memory 22 uses, for example, a semiconductor memory such as a RAM (Random Access Memory), a ROM (Read Only Memory), a flash memory, an EPROM (Erasable Programmable Read Only Memory), an EEPROM (Electrically Erasable Programmable Read-Only Memory) or the like; a magnetic disc; an optical disc; a magneto-optical disc; or the like.

Instead, as shown in FIG. 4B, the functions of the speech recognition unit 14, the speaking person identification unit 15, the response content setting unit 16, the response mode setting unit 17 and the response output control unit 18 may be implemented by a dedicated processing circuit 23. The processing circuit 23 uses, for example, an ASIC (Application Specific Integrated Circuit), a PLD (Programmable Logic Device), an FPGA (Field-Programmable Gate Array), a SoC (System-on-a-Chip), a system LSI (Large-Scale Integration), or the like.

Instead, a part of the functions of the speech recognition unit 14, the speaking person identification unit 15, the response content setting unit 16, the response mode setting unit 17 and the response output control unit 18 may be implemented by the processor 21 and the memory 22, and the other function(s) may be implemented by the processing circuit 23.

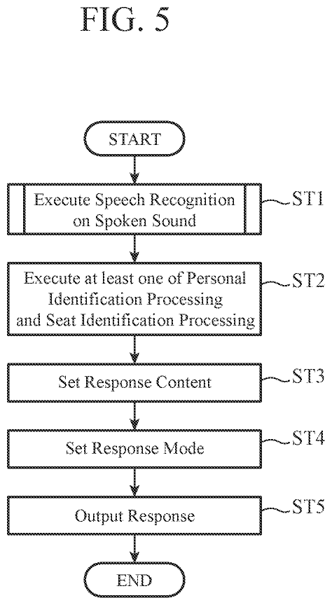

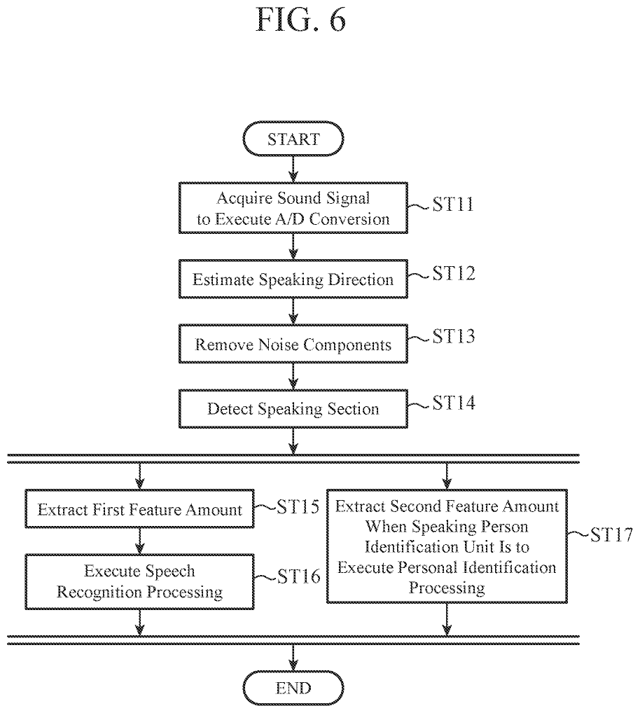

Next, with reference to the flowcharts of FIG. 5 and FIG. 6, description will be made about operations of the information apparatus 2. Note that Steps ST11 to ST17 shown in FIG. 6 represent detailed processing contents in Step ST1 shown in FIG. 5.

First, in Step ST1, the speech recognition unit 14 executes speech recognition on the spoken sound.

Namely, in Step ST11, the sound signal acquisition unit 11 acquires the sound signals S₁ to S_{N} outputted by the sound collection device 3. The sound signal acquisition unit 11 executes A/D conversion on the sound signals S₁ to S_{N}. The sound signal acquisition unit 11 outputs the sound signals S₁′ to S_{N}′ after A/D conversion, to the sound signal processing unit 12.

Then, in Step ST12, the sound signal processing unit 12 estimates an incoming direction of the spoken sound to the sound collection device 3, namely, a speaking direction, on the basis of: values of differences in power between the sound signals S₁′ to S_{N}′; phase differences between the sound signals S₁′ to S_{N}′; or the like.

Then, in Step ST13, the sound signal processing unit 12 removes components in the sound signals S₁′ to S_{N}′, that are corresponding to sounds different to the spoken sound, namely, the noise components, on the basis of the speaking direction estimated in Step ST12. The sound signal processing unit 12 outputs the sound signals S₁″ to S_{M}″ after removal of the noise components, to the speech recognition processing unit 13.

Then, in Step ST14, the speech recognition processing unit 13 detects a sound section corresponding to the spoken sound in the sound signals S₁″ to S_{M}″, namely, the speaking section.

Then, in Step ST15, the speech recognition processing unit 13 extracts the first feature amount for speech recognition processing from portions of the sound signals S₁″ to S_{M}″ in the speaking section. Then, in Step ST16, the speech recognition processing unit 13 executes speech recognition processing by using the first feature amount.

Further, when the speaking person identification unit 15 is that which executes the personal identification processing, in Step ST17 subsequent to Step ST14, the speech recognition processing unit 13 extracts the second feature amount for personal identification processing from portions of the sound signals S₁″ to S_{M}″ in the speaking section. Note that, when the speaking person identification unit 15 is that which does not execute the personal identification processing (namely, when the speaking person identification unit 15 is that which executes only the seat identification processing), processing in Step ST17 is unnecessary.

In Step ST2 subsequent to Step ST1, the speaking person identification unit 15 executes at least one of the personal identification processing and the seat identification processing. Specific examples of the personal identification processing and specific examples of the seat identification processing are as described previously, so that repetitive description thereof will be omitted.

Then, in Step ST3, the response content setting unit 16 executes the response content setting processing. Specific examples of the response content setting processing are as described previously, so that repetitive description thereof will be omitted.

Then, in Step ST4, the response mode setting unit 17 executes the response mode setting processing. Specific examples of the response mode setting processing are as described previously, so that repetitive description thereof will be omitted.

Then, in Step ST5, the response output control unit 18 executes the response output control. Specific examples of the response output control are as described previously, so that repetitive description thereof will be omitted.

It is noted that the sound collection device 3 is not limited to the array microphone constituted by the multiple non-directional microphones. For example, it is allowed that at least one directional microphone is provided at each portion in front of each of the speech recognition target seats and the sound collection device 3 is constituted by these directional microphones. In this case, the processing of estimating the speaking direction and the processing of removing the noise components on the basis of the thus-estimated speaking direction, are unnecessary in the sound signal processing unit 12. Further, for example, the seat identification processing is processing of determining that the speaking person is seated on the seat corresponding to the directional microphone from which the sound signal including components corresponding to the spoken sound is outputted.

Further, the response mode setting processing only has to set such a response mode that allows each of the multiple on-board persons seated on the speech recognition target seats to recognize whether or not the response is given to that person himself/herself, and thus the processing is not limited by the first to fifth specific examples. Further, the response mode setting processing is not limited to the processing of setting the output mode for a response speech nor to the processing of setting the display mode for a response image.

For example, it is allowed that a light emitting element, such as an LED (Light Emitting Diode), is provided at each portion in front of each of the speech recognition target seats and that, on the basis of the result of the seat identification processing, the response mode setting unit 17 sets, out of these light emitting elements, such a light emitting element that is provided at the portion in front of the seat on which the speaking person is seated, as a light emitting element to be lit. The response output control unit 18 may be that which executes control for lighting the light emitting element set to be lit by the response mode setting unit 17.

Further, for example, when there are multiple speaking persons, it is allowed that the response mode setting unit 17 sets the response mode (s) for only a certain speaking person(s) among the multiple speaking persons. It is also allowed that the response output control unit outputs a response(s) for the certain speaking person(s) among the multiple speaking persons on the basis of the response mode(s) set by the response mode setting unit 17 and, at the same time, executes control of outputting a response(s) for a speaking person(s) other than the above among the multiple speaking persons on the basis of a default response mode. Namely, the response mode setting processing only has to set a response mode for at least one speaking person among the multiple speaking persons.

Further, it is allowed that, at detection of each of the speaking sections, the speech recognition processing unit 13 detects the starting point of each of the spoken sounds. It is also allowed that the response mode setting unit 17 executes the response mode setting processing, only in the case where, after detection of the starting point of the spoken sound made by a first one of the speaking persons (hereinafter, referred to as a “first speaking person”) and before starting to output the response to the first speaking person, the starting point of the other spoken sound made by a second one of the speaking persons (hereinafter, referred to as a “second speaking person”) is detected. Ina case other than that, it is allowed that the response mode setting unit 17 does not execute the response mode setting processing, and the response output control unit 18 executes control for outputting the response based on the default response mode.

Further, in the former case, if setting of the response mode for the first speaking person would be too late for the start of outputting the response to the first speaking person (for example, if the starting point of the spoken sound made by the second speaking person is detected just before starting to output the response to the first speaking person), it is allowed that the response mode setting unit 17 does not execute the response mode setting processing for the first speaking person, and executes only the response mode setting processing for the second speaking person. If this is the case, the response to the first speaking person may be outputted according to a default response mode.

Instead, it is also allowed that the response mode setting unit 17 executes the response mode setting processing only in the case where, after detection of the starting point of the spoken sound made by the first speaking person and before elapse of a prescribed time (hereinafter, referred to as a “standard time”) therefrom, the starting point of the spoken sound made by the second speaking person is detected. In a case other than that, it is allowed that the response mode setting unit 17 does not execute the response mode setting processing and the response output control unit 18 executes control for outputting the response based on a default response mode. The standard time has, for example, a value corresponding to a statistical value (for example, an average value) obtained from actually measured values of the speaking times of various spoken sounds, and is prestored in the response mode setting unit 17.

Namely, when only the spoken sound made by one speaking person is inputted, only the response to the one speaking person is outputted. Further, when the spoken sounds made by multiple speaking persons are inputted without temporally overlapping each other, the responses to the respective speaking persons are also outputted without temporally overlapping each other. In these cases, even if the response mode setting processing is not executed, it is clear which person the response is given to. In these cases, if the response mode setting processing is cancelled, it is possible to reduce the processing load of the information apparatus 2. Further, in these cases, if the response mode setting processing according to, for example, the first specific example, is cancelled, it is possible to withhold the speaking person from getting a troublesome feeling from the nominal designation that would have been contained in the response speech or the response image.

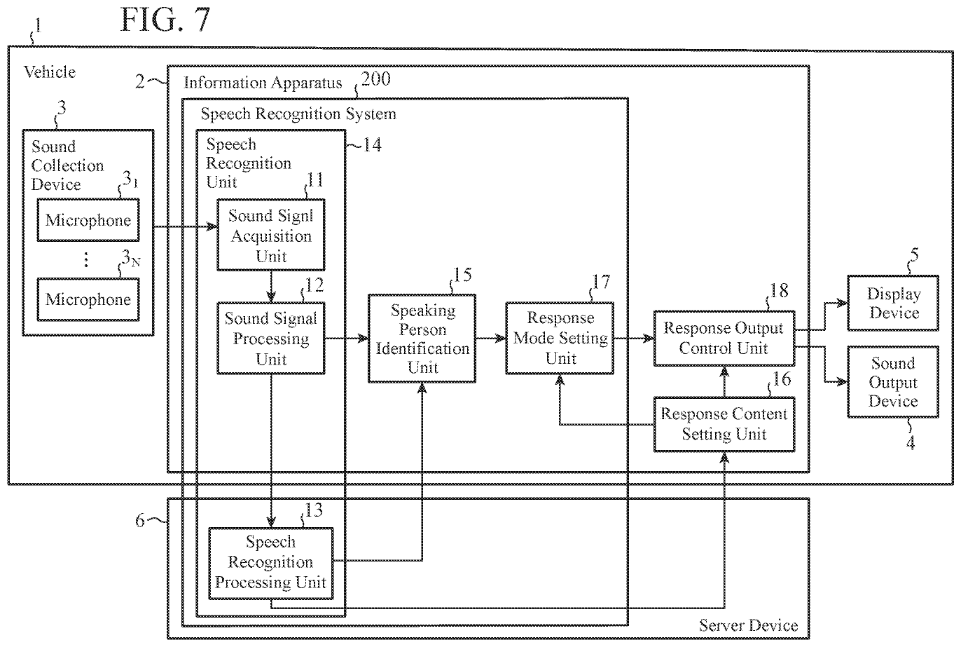

Meanwhile, as shown in FIG. 7, it is allowed that a server device 6 communicable with the information apparatus 2 is provided outside the vehicle 1 and the speech recognition processing unit 13 is provided in the server device 6. Namely, the main part of a speech recognition system 200 may be constituted by: the sound signal acquisition unit 11, the sound signal processing unit 12, the speaking person identification unit 15 and the response mode setting unit 17 that are provided in the information apparatus 2; and the speech recognition processing unit 13 provided in the server device 6. This makes it possible to improve the accuracy of the speech recognition processing in the speech recognition processing unit 13.

It is noted that the system configuration of the speech recognition system 200 is not limited to the case shown in FIG. 7. Namely, the sound signal acquisition unit 11, the sound signal processing unit 12, the speech recognition processing unit 13, the speaking person identification unit 15, the response content setting unit 16, the response mode setting unit 17 and the response output control unit 18 may each be provided in any one of an in-vehicle information device installable in the vehicle 1, a portable information terminal capable of being brought into the vehicle 1, and a server device communicable with the in-vehicle information device or the portable information terminal. It suffices that the speech recognition system 200 is implemented by any two or more of the in-vehicle information device, the portable information terminal and the server device, in cooperation.

As described above, the speech recognition device 100 of Embodiment 1 comprises: the speech recognition unit 14 for executing speech recognition on a spoken sound that is made for providing an operational input by a speaking person among multiple on-board persons seated on speech recognition target seats in the vehicle 1; the speaking person identification unit 15 for executing at least one of the personal identification processing of individually identifying the speaking person, and the seat identification processing of identifying the seat on which the speaking person is seated; and the response mode setting unit 17 for executing the response mode setting processing of setting a mode for a response (response mode) to the speaking person, according to a result identified by the speaking person identification unit 15; the response mode setting processing is processing in which the mode for the response (response mode) is set as a mode that allows each of the multiple on-board persons to recognize whether or not the response is given to the on-board person himself/herself. Accordingly, it is possible for each of the multiple on-board persons seated on the speech recognition target seats, to easily recognize whether or not the response is given to that person himself/herself. In particular, when the responses to multiple speaking persons are outputted at almost the same time, it is possible for each of the multiple speaking persons to easily recognize whether or not these responses are each given to that person himself/herself.

Further, the response mode setting unit 17 executes the response mode setting processing in the case where, after detection of a starting point of the spoken sound made by a first speaking person among the multiple speaking persons and before elapse of the standard time, a starting point of the other spoken sound made by a second speaking person among the multiple speaking persons is detected. This makes it possible to reduce the processing load, and to reduce the troublesome feeling given to the speaking person.

Further, the response mode setting unit 17 executes the response mode setting processing in the case where, after detection of a starting point of the spoken sound made by a first speaking person among the multiple speaking persons and before starting to output the response to the first speaking person, a starting point of the other spoken sound made by a second speaking person among the multiple speaking persons is detected. This makes it possible to reduce the processing load, and to reduce the troublesome feeling given to the speaking person.

Further, the speaking person identification unit 15 executes the personal identification processing by using the feature amount (second feature amount) extracted by the speech recognition unit 14. This makes it unnecessary to have a camera, a sensor or something like that, dedicated for the personal identification processing.

Further, the response mode setting processing is processing of adding to the response, a nominal designation based on the result identified by the speaking person identification unit 15. According to the first specific example, it is possible to achieve the response mode that allows each of the multiple speaking persons to easily recognize whether or not the response is given to that person himself/herself.

Further, the response mode setting processing is processing of changing a narrator for making a speech for use as the response (response speech), according to the result identified by the speaking person identification unit 15. According to the second specific example, it is possible to achieve the response mode that allows each of the multiple speaking persons to easily recognize whether or not the response is given to that person himself/herself.

Further, the response mode setting processing is processing of changing a speaker from which a speech for use as the response (response speech) is outputted, according to the position of the seat indicated by the result of the seat identification processing; or processing of changing a sound field at the time when a speech for use as the response (response speech) is outputted, according to the position of the seat indicated by the result of the seat identification processing. According to the third specific example or the fourth specific example, it is possible to achieve the response mode that allows each of the multiple speaking persons to easily recognize whether or not the response is given to that person himself/herself.

Further, the speech recognition system 200 of Embodiment 1 comprises: the speech recognition unit 14 for executing speech recognition on a spoken sound that is made for providing an operational input by a speaking person among multiple on-board persons seated on speech recognition target seats in the vehicle 1; the speaking person identification unit 15 for executing at least one of the personal identification processing of individually identifying the speaking person, and the seat identification processing of identifying the seat on which the speaking person is seated; and the response mode setting unit 17 for executing the response mode setting processing of setting a mode for a response (response mode) to the speaking person, according to a result identified by the speaking person identification unit 15; the response mode setting processing is processing in which the mode for the response (response mode) is set as a mode that allows each of the multiple on-board persons to recognize whether or not the response is given to the on-board person himself/herself. Accordingly, it is possible to achieve an effect similar to the above-described effect according to the speech recognition device 100.

Further, the speech recognition method of Embodiment 1 comprises: Step ST1 in which the speech recognition unit 14 executes speech recognition on a spoken sound that is made for providing an operational input by a speaking person among multiple on-board persons seated on speech recognition target seats in the vehicle 1; Step ST2 in which the speaking person identification unit 15 executes at least one of the personal identification processing of individually identifying the speaking person, and the seat identification processing of identifying the seat on which the speaking person is seated; and Step ST4 in which the response mode setting unit 17 executes the response mode setting processing of setting a mode for a response (response mode) to the speaking person, according to a result identified by the speaking person identification unit 15; the response mode setting processing is processing in which the mode for the response (response mode) is set as a mode that allows each of the multiple on-board persons to recognize whether or not the response is given to the on-board person himself/herself. Accordingly, it is possible to achieve an effect similar to the above-described effect according to the speech recognition device 100.

### Embodiment 2

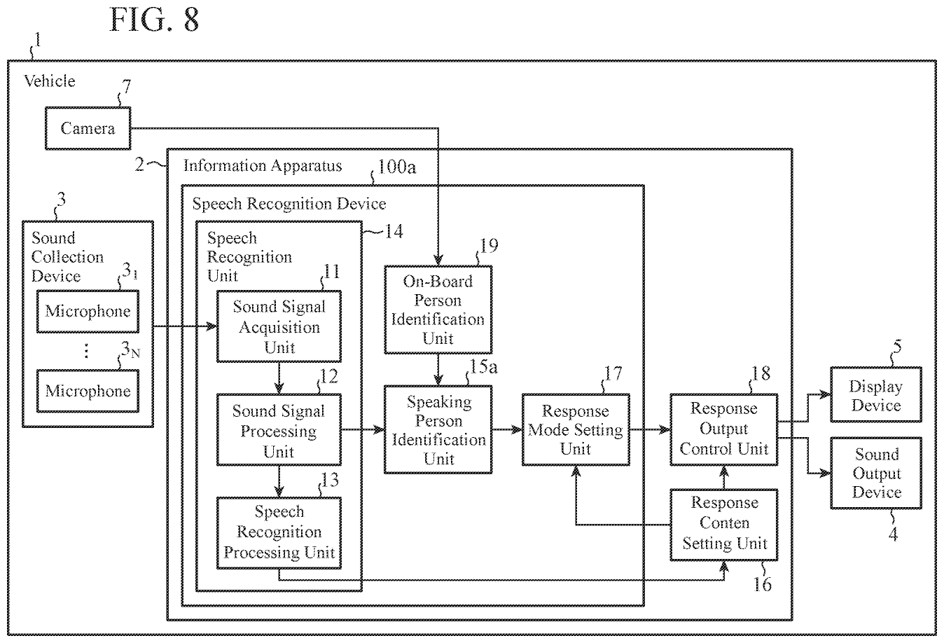

FIG. 8 is a block diagram showing a state in which a speech recognition device according to Embodiment 2 is provided in an information apparatus in a vehicle. With reference to FIG. 8, description will be made about a speech recognition device 100a of Embodiment 2, focusing on a case where it is provided in an information apparatus 2 in a vehicle 1. Note that in FIG. 8, for the blocks similar to the blocks shown in FIG. 1, the same numerals are given, so that description thereof will be omitted.

In the figure, reference numeral 7 denotes a vehicle-interior imaging camera. The camera 7 is configured with, for example, an infrared camera or a visible-light camera provided in a vehicle-interior front section of the vehicle 1. The camera 7 has at least a viewing angle that allows the camera to image a region including faces of the on-board persons seated on the speech recognition target seats (for example, the driver's seat and the front passenger's seat).

An on-board person identification unit 19 serves to acquire at a constant period (for example, a period of 30 FPS (Frames Per Second)), image data representing the image captured by the camera 7. The on-board person identification unit 19 serves to execute image recognition processing on the thus-acquired image data, thereby to determine presence/absence of the on-board person on each of the speech recognition target seats and to execute processing of individually identifying each on-board person seated on the speech recognition target seat (hereinafter, referred to as “on-board person identification processing”).

Specifically, for example, the on-board person identification unit 19 executes the image recognition processing, thereby to detect in the captured image, each area (hereinafter, referred to as a “face area”) corresponding to the face of each on-board person seated on the speech recognition target seat, and to extract from each face area, a feature amount for on-board person identification processing (hereinafter, referred to as a “third feature amount”). The on-board person identification unit 19 determines presence/absence of the on-board person on each of the speech recognition target seats, on the basis of the size, the position, etc. of each face area in the captured image. Further, in the on-board person identification unit 19, a database is prestored in which feature amounts of multiple persons each corresponding to a third feature amount are included. By comparing the third feature amount extracted from each face area with each of the feature amounts of multiple persons, the on-board person identification unit 19 individually identifies each on-board person seated on the speech recognition target seat.

The on-board person identification unit 19 outputs the result of the on-board person identification processing to a speaking person identification unit 15a. The result of the on-board person identification processing includes, for example, information indicating the name or the like of each on-board person seated on the speech recognition target seat, and information indicating the name, the position or the like of the seat on which each on-board person is seated. Note that, when no on-board person is seated on a certain seat(s) in the speech recognition target seats, the result of the on-board person identification processing may include only the above set of information, or may include, in addition to the above set of information, information indicating that the certain seat(s) is an empty seat(s).

The speaking person identification unit 15a serves to execute processing of individually identifying the speaking person, namely, the personal identification processing, by using the speaking direction estimated by the sound signal processing unit 12 and the result of the on-board person identification processing by the on-board person identification unit 19.

Specifically, for example, in the speaking person identification unit 15a, actual angles Φ, that are similar to the actual angles Φ for the seat identification processing in Embodiment 1, are prestored. By comparing the angle θ indicated by the speaking direction estimated by the sound signal processing unit 12 with the actual angle Φ corresponding to each of the speech recognition target seats, the speaking person identification unit 15a identifies the seat on which the speaking person is seated. The speaking person identification unit 15a individually identifies the on-board person seated on the thus-identified seat, that is, the speaking person, by using the result of the on-board person identification processing by the on-board person identification unit 19.

Namely, unlike the speaking person identification unit 15 in the speech recognition device 100 of Embodiment 1, the speaking person identification unit 15a does not use the second feature amount for the personal identification processing. Thus, in the speech recognition device 100a of Embodiment 2, the speech recognition processing unit 13 is not required to extract the second feature amount.

The response mode setting unit 17 serves to use the result of the personal identification processing by the speaking person identification unit 15a, for the response mode setting processing. Specific examples of the response mode setting processing are as described in Embodiment 1, so that repetitive description thereof will be omitted.

By the speech recognition unit 14, the speaking person identification unit 15a, the response mode setting unit 17 and the on-board person identification unit 19, the main part of the speech recognition device 100a is constituted. By the speech recognition device 100a, the response content setting unit 16 and the response output control unit 18, the main part of the information apparatus 2 is constituted.

Hardware configurations of the main part of the information apparatus 2 are similar to those described in Embodiment 1 with reference to FIG. 4, so that repetitive description thereof will be omitted. Namely, the function of the speaking person identification unit 15a may be implemented by a processor 21 and a memory 22, or may be implemented by a processing circuit 23. Likewise, the function of the on-board person identification unit 19 may be implemented by a processor 21 and a memory 22, or may be implemented by a processing circuit 23.

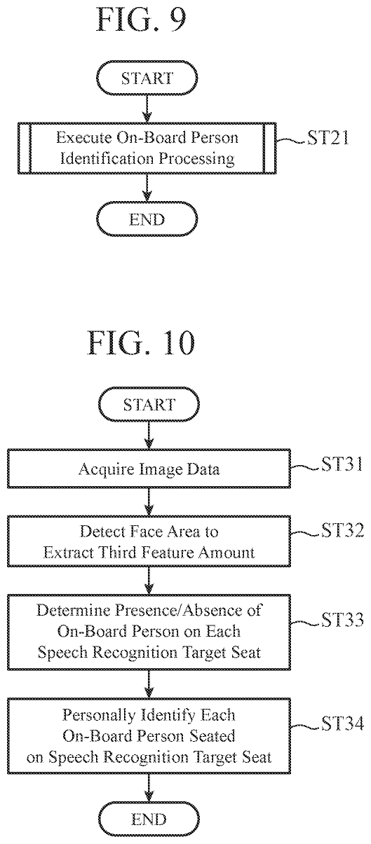

Next, with reference to the flowcharts of FIG. 9 and FIG. 10, description will be made about operations of the on-board person identification unit 19. Note that Steps ST31 to ST34 shown in FIG. 10 represent detailed processing contents in Step ST21 shown in FIG. 9.

In a state where the accessory power supply of the vehicle 1 is turned ON, the on-board person identification unit 19 acquires at a constant period, image data representing the image captured by the camera 7, to thereby execute the on-board person identification processing by using thus-acquired image data (Step ST21).

Namely, in Step ST31, the on-board person identification unit 19 acquires the image data representing the image captured by the camera 7.

Then, in Step ST32, the on-board person identification unit 19 executes image recognition processing on the image data acquired in Step ST31, thereby to detect each face area in the captured image, and to extract the third feature amount for on-board person identification processing from each face area.

Then, in Step ST33, the on-board person identification unit 19 determines presence/absence of the on-board person on each of the speech recognition target seats, on the basis of the size, the position, etc. of each face area detected in Step ST32.

Then, in Step ST34, the on-board person identification unit 19 identifies each on-board person on the speech recognition target seat, by using the third feature amount extracted in Step ST33.

The on-board person identification unit 19 outputs the result of the on-board person identification processing, to the speaking person identification unit 15a.

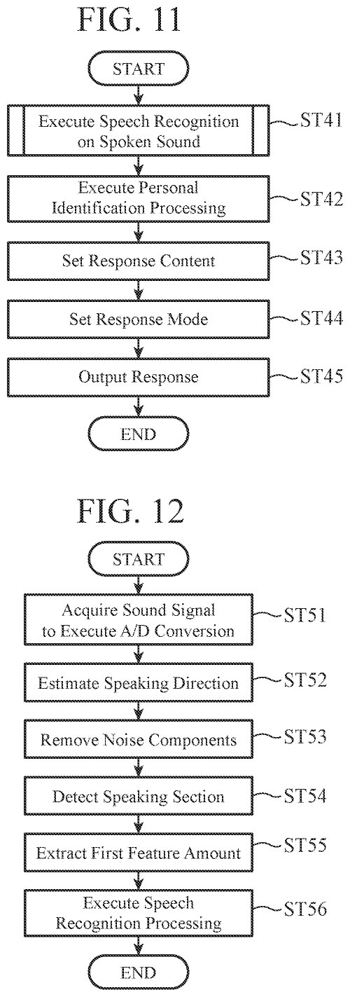

Next, with reference to the flowcharts of FIG. 11 and FIG. 12, description will be made about operations of the parts other than the on-board person identification unit 19 in the information apparatus 2. Note that Steps ST51 to ST56 shown in FIG. 12 represent detailed processing contents in Step ST41 shown in FIG. 11.

First, in Step ST41, the speech recognition unit 14 executes speech recognition processing on the spoken sound.

Namely, in Step ST51, the sound signal acquisition unit 11 acquires the sound signals S₁ to S_{N} outputted by the sound collection device 3. The sound signal acquisition unit 11 executes A/D conversion on the sound signals S₁ to S_{N}. The sound signal acquisition unit 11 outputs the sound signals S₁′ to S_{N}′ after A/D conversion, to the sound signal processing unit 12.

Then, in Step ST52, the sound signal processing unit 12 estimates an incoming direction of the spoken sound to the sound collection device 3, namely, the speaking direction, on the basis of: values of differences in power between the sound signals S₁′ to S_{N}′; phase differences between the sound signals S₁′ to S_{N}′; or the like.

Then, in Step ST53, the sound signal processing unit 12 removes components in the sound signals S₁′ to S_{N}′, that are corresponding to sounds different to the spoken sound, namely, the noise components, on the basis of the speaking direction estimated in Step ST52. The sound signal processing unit 12 outputs the sound signals S₁″ to S_{M}″ after removal of the noise components, to the speech recognition processing unit 13.

Then, in Step ST54, the speech recognition processing unit 13 detects a sound section corresponding to the spoken sound in the sound signals S₁″ to S_{M}″, namely, the speaking section.

Then, in Step ST55, the speech recognition processing unit 13 extracts the first feature amount for speech recognition processing from portions of the sound signals S₁″ to S_{M}″ in the speaking section. Then, in Step ST56, the speech recognition processing unit 13 executes the speech recognition processing by using the first feature amount.

In Step ST42 subsequent to Step ST41, the speaking person identification unit 15a executes the personal identification processing. Namely, the speaking person identification unit 15a executes processing of individually identifying the speaking person according to the foregoing specific example, by using the speaking direction estimated in Step ST52 by the sound signal processing unit 12 and the result of the on-board person identification processing outputted in Step ST34 by the on-board person identification unit 19.

Then, in Step ST43, the response content setting unit 16 executes the response content setting processing. Specific examples of the response content setting processing are as described in Embodiment 1, so that repetitive description thereof will be omitted.

Then, in Step ST44, the response mode setting unit 17 executes the response mode setting processing. Specific examples of the response mode setting processing are as described in Embodiment 1, so that repetitive description thereof will be omitted.

Then, in Step ST45, the response output control unit 18 executes the response output control. Specific examples of the response output control are as described in Embodiment 1, so that repetitive description thereof will be omitted.

In this manner, provision of the on-board person identification unit 19 can make unnecessary the second feature amount to be extracted from the sound signals S₁″ to S_{M}″, in the personal identification processing. As a result, noise tolerance for the personal identification processing can be enhanced, so that the accuracy of the personal identification processing can be improved.

It is noted that three-dimensional position coordinates of the head of each on-board person seated on the speech recognition target seat, more preferably, three-dimensional position coordinates of the mouth of that on-board person, may be detected according to the image recognition processing in the on-board person identification unit 19. The sound signal processing unit 12 may be that which estimates a more-highly directional speaking direction (for example, a speaking direction represented by a horizontal direction angle θ and a vertical direction angle Ψ, both relative to the central axis that is referenced to the placement position of the sound collection device 3) by using the three-dimensional position coordinates detected by the on-board person identification unit 19. This makes it possible to improve the estimation accuracy of the speaking direction, so that the noise-component removal accuracy can be improved. In FIG. 8, a connection line to be given in this case between the on-board person identification unit 19 and the sound signal processing unit 12 is omitted from the illustration.

Further, the speaking person identification unit 15a may be that which detects from the on-board persons seated on the speech recognition target seats, an on-board person moving the mouth, by acquiring image data representing the image captured by the camera 7 and executing image recognition processing on the thus-acquired image data. The speaking person identification unit 15a may be that which individually identifies the on-board person moving the mouth, namely, the speaking person, by using the result of the on-board person identification processing by the on-board person identification unit 19. In either case, since the speaking direction to be estimated by the sound signal processing unit 12 is unnecessary in the personal identification processing, a connection line shown in FIG. 8 between the sound signal processing unit 12 and the speaking person identification unit 15a is unnecessary. Note that, in FIG. 8, a connection line to be given in that case between the camera 7 and the speaking person identification unit 15a is omitted in the illustration.

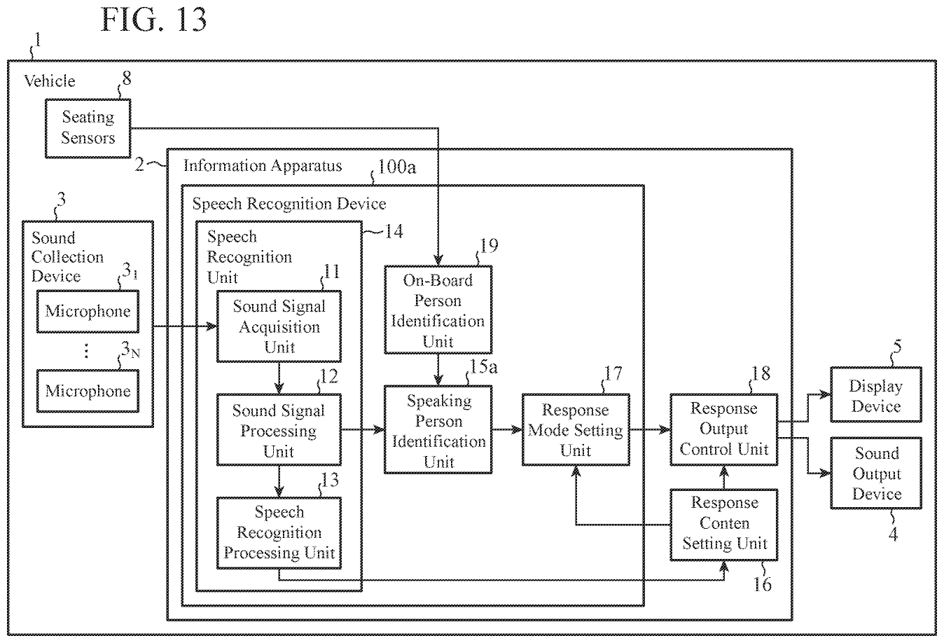

Further, as shown in FIG. 13, it is allowed that seating sensors 8 are provided on seating surface portions of the respective speech recognition target seats, and the on-board person identification unit 19 executes the on-board person identification processing by using values detected by these seating sensors 8. Namely, each of the seating sensors 8 is configured with, for example, multiple pressure sensors. The pressure distribution detected by the multiple pressure sensors differs depending on the weight, the seated posture, the hip contour or the like, of the on-board person seated on the corresponding seat. Using such a pressure distribution as a feature amount, the on-board person identification unit 19 executes the on-board person identification processing. As the method of identifying the person by using the pressure distribution as a feature amount, any one of publicly known various methods may be used, so that detailed description thereof will be omitted.

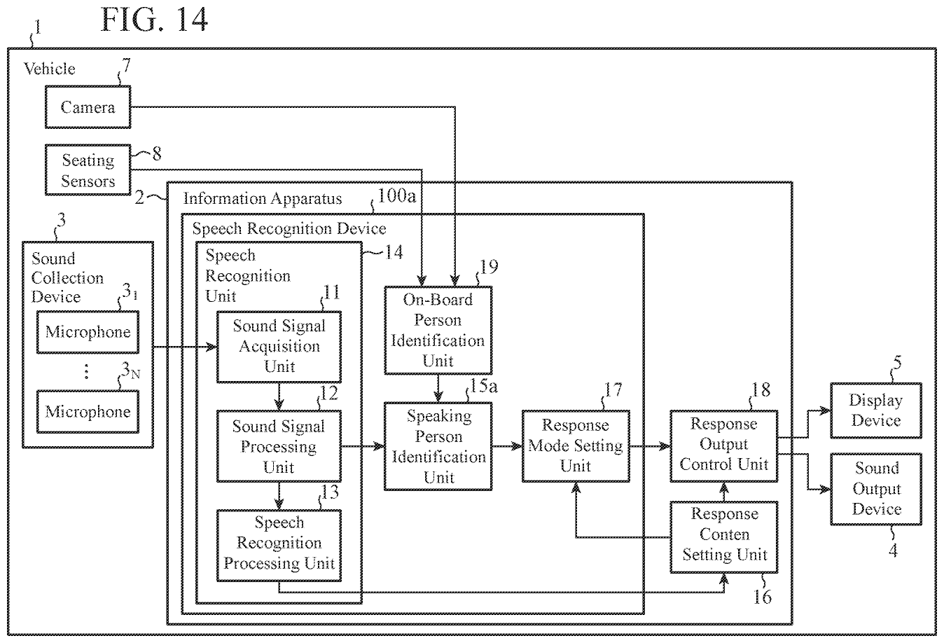

Further, the on-board person identification unit 19 may be that which executes both the on-board person identification processing using an image captured by the camera 7 and the on-board person identification processing using values detected by the seating sensors 8. This makes it possible to improve the accuracy of the on-board person identification processing. A block diagram according to this case is shown as FIG. 14.

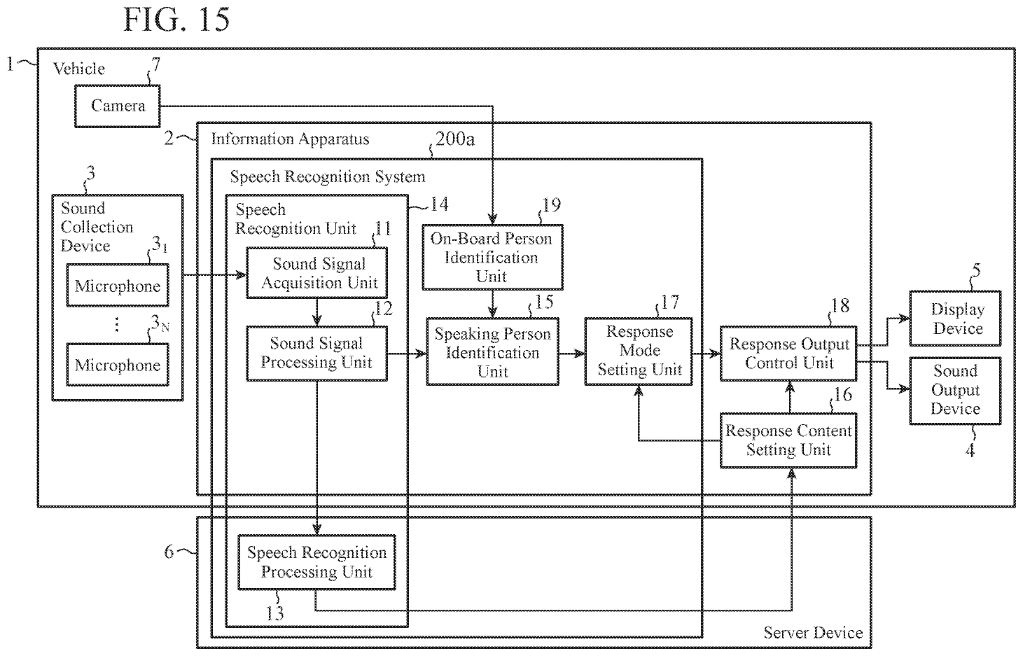

Further, as shown in FIG. 15, the main part of a speech recognition system 200a may be constituted by: the sound signal acquisition unit 11, the sound signal processing unit 12, the speaking person identification unit 15a, the response mode setting unit 17 and the on-board person identification unit 19, that are provided in the information apparatus 2; and the speech recognition processing unit 13 provided in the server device 6. This makes it possible to improve the accuracy of the speech recognition processing in the speech recognition processing unit 13.

Further, in the speech recognition system 200a, the speaking person identification unit 15a may be that which executes the on-board person identification processing by using values detected by the seating sensors 8, instead of, or in addition to, the image captured by the camera 7. A block diagram according to this case is omitted from illustration.

Other than the above, various modification examples similar to those described in Embodiment 1, namely, various modification examples similar to those for the speech recognition device 100 shown in FIG. 1, may be applied to the speech recognition device 100a. Likewise, various modification examples similar to those described in Embodiment 1, namely, various modification examples similar to those for the speech recognition system 200 shown in FIG. 7, may be applied to the speech recognition system 200a.

As described above, the speech recognition device 100a of Embodiment 2 comprises the on-board person identification unit 19 for executing the on-board person identification processing of identifying each of the multiple on-board persons by using at least one of the vehicle-interior imaging camera 7 and the seating sensors 8; the speaking-person identification unit 15a executes the personal identification processing by using the result of the on-board person identification processing. This makes it possible to enhance noise tolerance for the personal identification processing, so that the accuracy of the personal identification processing can be improved.

It should be noted that unlimited combination of the respective embodiments, modification of any configuration element in the embodiments and omission of any configuration element in the embodiments may be made in the present invention without departing from the scope of the invention.

### INDUSTRIAL APPLICABILITY

The speech recognition device of the invention can be used for providing an operational input to, for example, an information apparatus in a vehicle.

### REFERENCE SIGNS LIST

1: vehicle, 2: information apparatus, 3: sound collection device, 3₁ to 3_{N}: microphones, 4: sound output device, 5: display device, 6: server device, 7: camera, 8: seating sensor, 11: sound signal acquisition unit, 12: sound signal processing unit, 13: speech recognition processing unit, 14: speech recognition unit, 15, 15a: speaking person identification unit, 16: response content setting unit, 17: response mode setting unit, 18: response output control unit, 19: on-board person identification unit, 21: processor, 22: memory, 23: processing circuit, 100, 100a: speech recognition device, 200, 200a: speech recognition system.

1-12. (canceled)

13. A speech recognition device, comprising:
processing circuitry to
execute speech recognition on a spoken sound that is made for an operational input by at least one speaking person among multiple on-board persons seated on speech recognition target seats in a vehicle, the at least one speaking person including multiple speaking persons;
execute at least one of personal identification processing of individually identifying the at least one speaking person; and seat identification processing of identifying the seat on which the at least one speaking person is seated; and
execute, when it is likely that responses to the multiple speaking persons temporally overlap each other, response mode setting processing of setting a mode for a response to the at least one speaking person, in accordance with the identified result;
wherein the response mode setting processing is processing in which the mode for the response is set as a mode that allows each of the multiple on-board persons to determine whether to be subjected to the response.

14. The speech recognition device of claim 13,
wherein the at least one speaking person includes a first speaking person and a second speaking person,
wherein the processing circuitry executes the response mode setting processing in a case where, after detection of a starting point of a spoken sound made by the first speaking person and before elapse of a standard time, a starting point of another spoken sound made by the second speaking person is detected.

15. The speech recognition device of claim 13,
wherein the at least one speaking person includes a first speaking person and a second speaking person,
wherein the processing circuitry executes the response mode setting processing in a case where, after detection of a starting point of a spoken sound made by the first speaking person and before starting to output the response to the first speaking person, a starting point of another spoken sound made by the second speaking person is detected.

16. The speech recognition device according to claim 13, wherein the processing circuitry executes the personal identification processing by using the extracted feature amount.

17. The speech recognition device according to claim 13,
wherein the processing circuitry further executes on-board person identification processing of individually identifying each of the multiple on-board persons by using at least one of a vehicle-interior imaging camera and a seating sensor,
wherein the processing circuitry executes the personal identification processing by using a result of the on-board person identification processing.

18. The speech recognition device according to claim 13,
wherein the response mode setting processing is processing of adding to the response, a nominal designation for the at least one speaking person based on the identified result.

19. The speech recognition device of claim 18,
wherein the response mode setting processing is processing of adding the nominal designation to speech for use as the response.

20. The speech recognition device of claim 18,
wherein the response mode setting processing is processing of adding the nominal designation to an image for use as the response.

21. The speech recognition device according to claim 13,
wherein the response mode setting processing is processing of changing a virtual narrator for speech for use as the response, the narrator being outputted from a sound output device, in accordance with the identified result.

22. The speech recognition device according to claim 13,
wherein the response mode setting processing is processing of changing a speaker from which speech for use as the response is outputted, in accordance with a position of the seat indicated by a result of the seat identification processing; or processing of changing a sound field at a time when the speech for use as the response is outputted, in accordance with the position of the seat indicated by the result of the seat identification processing.

23. The speech recognition device according to claim 13,
wherein the response mode setting processing is processing of setting a region where an image for use as the response is to be displayed in a display area of a display device, in accordance with a position of the seat indicated by a result of the seat identification processing.

24. A speech recognition system, comprising:
processing circuitry to
execute speech recognition on a spoken sound that is made for an operational input by at least one speaking person among multiple on-board persons seated on speech recognition target seats in a vehicle, the at least one speaking person including multiple speaking persons;
execute at least one of personal identification processing of individually identifying the at least one speaking person; and seat identification processing of identifying the seat on which the at least one speaking person is seated; and
execute, when it is likely that responses to the multiple speaking persons temporally overlap each other, response mode setting processing of setting a mode for a response to the at least one speaking person, in accordance with the identified result;
wherein the response mode setting processing is processing in which the mode for the response is set as a mode that allows each of the multiple on-board persons to determine whether to be subjected to the response.

25. A speech recognition method, comprising:
executing speech recognition on a spoken sound that is made for an operational input by at least one speaking person among multiple on-board persons seated on speech recognition target seats in a vehicle, the at least one speaking person including multiple speaking persons;
executing at least one of personal identification processing of individually identifying the at least one speaking person and seat identification processing of identifying the seat on which the at least one speaking person is seated; and
executing when it is likely that responses to the multiple speaking persons temporally overlap each other, response mode setting processing of setting a mode for a response to the at least one speaking person, in accordance with the identified result,
wherein the response mode setting processing is processing in which the mode for the response is set as a mode that allows each of the multiple on-board persons to determine whether to be subjected to the response.
